(19) United States
(12) Patent Application Publication
(10) Pub. No.: US 2005/0259951 A1
(43) Pub. Date: Nov. 24, 2005

(54) Advertisement presenting apparatus, advertisement presentation aiding system, advertisement presenting method, and program

(76) Inventor: Hiroki Sugahara, Kanagawa (JP)

Correspondence Address: MORRISON & FOERSTER LLP, 1650 TYSONS BOULEVARD, SUITE 300, MCLEAN, VA, 22102, US

(21) Appl. No.: 11/116,410

(22) Filed: Apr. 28, 2005

(30) Foreign Application Priority Data
Apr. 28, 2004 (JP) 2004-134232

(51) Int. Cl. H04N 5/76; H04N 5/781

(52) U.S. Cl. 386/46; 386/125

(57) ABSTRACT

An advertiser registers advertisement data in a server of a TV station. An advertisement presenting apparatus receives a video signal and an audio signal of a TV program, information about the program, and the advertisement data. A control section starts recording the TV program in a recording/reproducing section in response to a request from a user. When finishing recording, the control section causes a printing section to print information, which allows the user to easily grasp recorded contents, and an advertisement image based on the advertisement data on the top surface of an information recording medium, such as a DVD. The control section transmits an advertisement print notification to the server of the TV station. Having receiving the advertisement print notification, the server computes an advertising rate and charges the advertiser for the rate.

### BACKGROUND OF THE INVENTION

1. Field of the Invention

The present invention relates to an advertisement presenting apparatus, an advertisement presentation aiding system and an advertisement presenting method which are suitable for presenting an advertisement on the top surface of an information recording medium.

2. Description of the Related Art

There are various method of advertising merchandise, services, etc. of enterprises or the like to clients. For example, one way is to present an advertisement medium, such as a poster, showing the contents of an advertisement in given advertising space.

Advertising merchandise or the like demands that a greater number of people should know the merchandise or the like. In the present situation where users' needs for goods or the like are diversified, particularly, more effective advertising is required. For instance, it is very important for a seller of merchandise or the like to efficiently advertise to a target layer of customers. In addition, some consideration is given to advertising by way of media which have not been used so far as advertising media.

Unexamined Japanese Patent Application KOKAI Publication No. 2002-279292 discloses one way of advertising merchandise or the like. Specifically, an image of the contents of an advertisement is printed on the rear side of a copy sheet on whose top side a copy is made by a client using a copying machine in a convenience store or so.

Recently, information recording media, such as DVD (Digital Versatile Disk) and CD (Compact Disk), on which video images of movies or so are recorded are used by a lot of people. In general, those information recording media are used for the purpose of distributing and saving contents, such as movies, music and programs. The information recording media are excellent not only in data storage stability but also in distributability for their simple usage. The use of those information recording media as advertising media therefore seems to be able to ensure more effective advertising.

### SUMMARY OF THE INVENTION

Accordingly, it is an object of the present invention to provide an advertisement presenting apparatus, an advertisement presentation aiding system and an advertisement presenting method which are suitable for presenting an advertisement on the top surface of an information recording medium.

To achieve the object, an advertisement presenting apparatus according to the first aspect of the invention comprises a record information receiving section, an advertisement image information receiving section, a recording section and a presenting section, which are so constructed as to provide the following capabilities.

The record information receiving section receives record information to be recorded in an information recording medium.

The advertisement image information receiving section receives advertisement image information indicating contents of an advertisement.

The recording section records the record information, received by the record information receiving section, in the information recording medium.

The presenting section presents the advertisement image information, received by the advertisement image information receiving section, on a top surface of the information recording medium where the record information is recorded by the recording section.

The advertisement presenting apparatus can be constructed as follows.

The advertisement image information receiving section receives advertisement image information corresponding to the record information received by the register section.

The advertisement presenting apparatus can be constructed as follows.

The advertisement image information receiving section receives advertisement image information corresponding to a time at which the record information is recorded in the information recording medium by the recording section.

The advertisement presenting apparatus can be constructed as follows.

The presenting section presents, on the top surface of the information recording medium, information by which contents of the record information recorded in the information recording medium by the recording section can be grasped.

The advertisement presenting apparatus can be constructed as follows.

The information by which the contents of the record information can be grasped includes at least one of a genre, a title, a recording date, a recording mode and a remaining recordable time.

An advertisement presentation aiding system according to the second aspect of the invention comprises the advertisement presenting apparatus according to the first aspect of the invention, and can be constructed in such a way that the advertisement presentation aiding system presents advertisement image information indicating contents of an advertisement on a top surface of an information recording medium.

The advertisement presentation aiding system further comprises a server unit comprising a record information storing section, an advertisement image information receiving section, a record information transmitting section and an advertisement image information transmitting section.

The record information storing section stores record information recordable in an information recording medium.

The advertisement image information storing section stores advertisement image information indicating contents of an advertisement in association with the record information.

The record information transmitting section transmits the record information stored in the information recording medium.

The advertisement image information transmitting section transmits the advertisement image information stored in the advertisement image information storing section, and transmits advertisement image information associated with the record information transmitted by the record information transmitting section.

The advertisement presentation aiding system can be constructed as follows.

The advertisement image information transmitting section transmits advertisement image information corresponding to a time at which the record information transmitting section has transmitted the record information.

An advertisement presenting method according to the third aspect of the invention comprises a record information receiving step, an advertisement image information receiving step, a recording step, and a presenting step.

At the record information receiving step, record information to be recorded in an information recording medium is received.

At the advertisement image information receiving step, advertisement image information indicating contents of an advertisement is received.

At the recording step, the record information, received at the record information receiving step, is recorded in the information recording medium.

At the presenting step, the advertisement image information, received at the advertisement image information receiving step, is presented on a top surface of the information recording medium where the record information is recorded at the recording step.

A program according to the fourth aspect of the invention allows a computer to function as a record information receiving section, an advertisement image information receiving section, a recording section, and a presenting section, which are so constructed as to provide the following capabilities.

The record information receiving section receives record information to be recorded in an information recording medium.

The advertisement image information receiving section receives advertisement image information indicating contents of an advertisement.

The recording section records the record information, received by the record information receiving section, in the information recording medium.

The presenting section presents the advertisement image information, received by the advertisement image information receiving section, on a top surface of the information recording medium where the record information is recorded by the recording section.

The invention can provide an advertisement presenting apparatus, an advertisement presentation aiding system and an advertisement presenting method which are suitable for presenting an advertisement on the top surface of an information recording medium.

### BRIEF DESCRIPTION OF THE DRAWINGS

These objects and other objects and advantages of the present invention will become more apparent upon reading of the following detailed description and the accompanying drawings in which:

FIG. 1 is a diagram showing the configuration of an advertisement presentation aiding system according to one embodiment of the present invention;

FIG. 2 is a diagram showing the configuration of a server in the advertisement presentation aiding system;

FIG. 3 is a diagram showing the structure of a database in the advertisement presentation aiding system;

FIG. 4 is a diagram showing the structure of a program information database;

FIG. 5 is a diagram showing the structure of a program schedule information database;

FIG. 6 is a diagram showing the structure of an advertisement information database;

FIG. 7 is a diagram showing the structure of an advertisement schedule information database;

FIG. 8 is a diagram showing the structure of a charge information database;

FIG. 9 is a diagram showing the configuration of an advertisement presenting apparatus;

FIG. 10 is a flowchart illustrating an advertisement presenting routine;

FIG. 11 is a diagram showing one example of a DVD on whose top surface advertisement information or so is printed;

FIG. 12 is a diagram showing the configuration of an advertisement presentation aiding system according to another embodiment of the invention; and

FIGS. 13A and 13B are flowcharts illustrating a routine for computing an advertising rate, FIG. 13A being a flowchart illustrating a process of receiving an advertisement print notification while FIG. 13B is a flowchart illustrating a process of charging an advertiser for an advertising rate.

### DETAILED DESCRIPTION OF THE PREFERRED EMBODIMENTS

### First Embodiment

An advertisement presenting apparatus, an advertisement presentation aiding system, and an advertisement presenting method according to a first embodiment of the present invention will now be described with reference to the accompanying drawings. According to the embodiment, an image relating to the contents of an advertisement is presented (printed) on the top surface of a DVD (Digital Versatile Disk) as an information recording medium. In the embodiment, programs (video signals and audio signals) to be broadcast from a television (TV) station are used as record information to be recorded on an information recording medium. The following description of the invention will be given of a case where a viewer records the programs on a DVD.

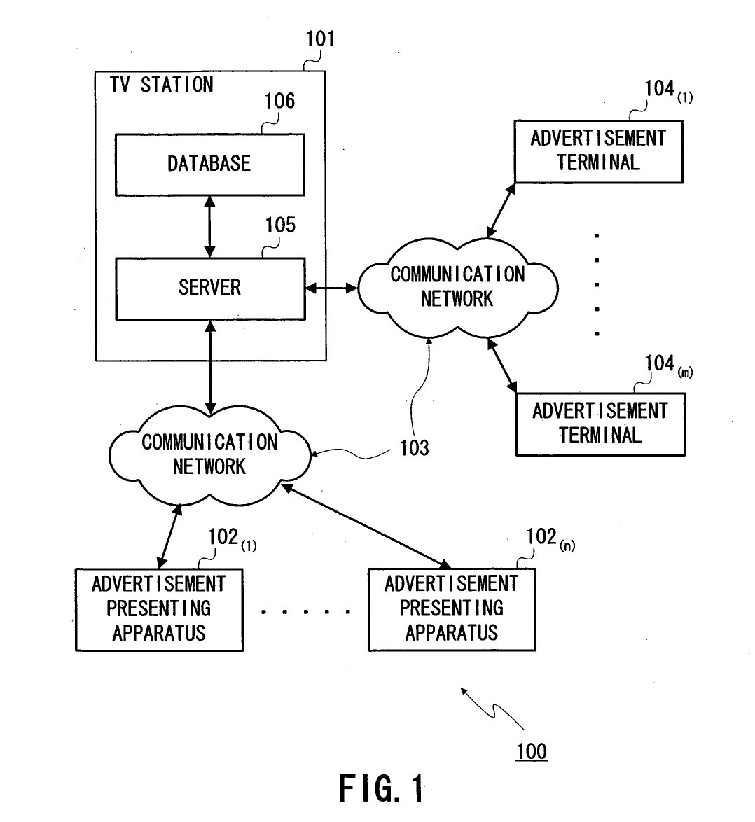

FIG. 1 is a diagram showing an example of an advertisement presentation aiding system 100.

As shown in FIG. 1, the advertisement presentation aiding system 100 comprises a TV station 101, and advertisement presenting apparatuses 102 (102₍₁₎ to 102₍ₙ₎) capable of receiving and recording programs (video signals and audio signals) distributed by the TV station 101. As illustrated in the diagram, the advertisement presentation aiding system 100 further comprises a communication network 103 and advertisement terminals 104 (104₍₁₎ to 104₍ₘ₎) connected to one another over the communication network 103. The advertisement terminal 104 is used to perform processes including recording of an image relating to the contents of an advertisement to be presented on the top surface of a DVD as will be discussed later.

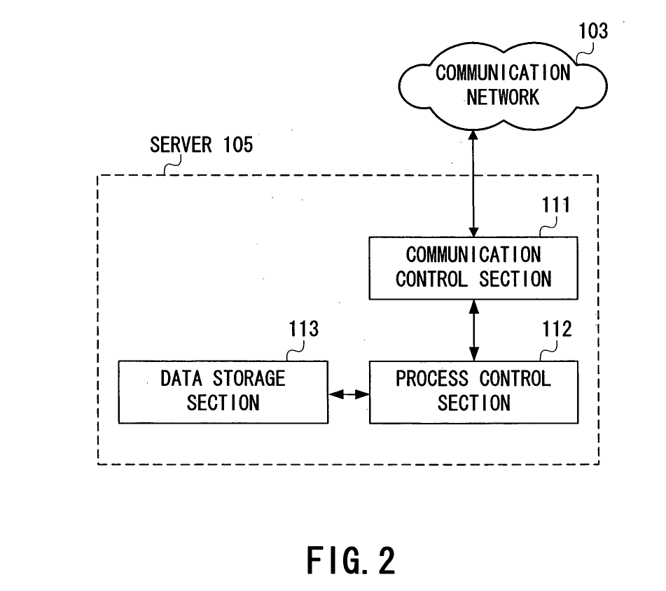

The TV station 101 comprises a server 105 and a database 106. FIG. 2 shows the configuration of the server 105. As illustrated in FIG. 2, the server 105 comprises a communication control section 111, a process control section 112, and a data storage section 113.

The communication control section 111 is constituted by, for example, a predetermined communication apparatus. The communication control section 111 connects the server 105 to the communication network 103. The communication control section 111 distributes programs (video signals and audio signals) to be broadcast.

The process control section 112 communicates with the advertisement presenting apparatuses 102 and the advertisement terminals 104, present on the communication network 103, via the communication control section 111. The process control section 112 has, for example, a CPU (Central Processing Unit). The process control section 112 executes various processes by running a program read from the data storage section 113.

The data storage section 113, which is constituted by a semiconductor memory, a magnetic disk recording unit or so, stores various kinds of information and programs.

The database 106 of the advertisement presentation aiding system 100 will now be described.

The communication control section 111 is constituted by, for example, a predetermined communication apparatus. The communication control section 111 connects the server 105 to the communication network 103. The communication control section 111 distributes programs (video signals and audio signals) to be broadcast.

The process control section 112 communicates with the advertisement presenting apparatuses 102 and advertisement terminals 104, present on the communication network 103, via the communication control section 111. The process control section 112 has, for example, a CPU (Central Processing Unit). The process control section 112 executes various processes by running a program read from the data storage section 113.

The data storage section 113, which is constituted by a semiconductor memory, a magnetic disk recording unit or so, stores various kinds of information and programs.

The database 106 of the advertisement presentation aiding system 100 will now be described.

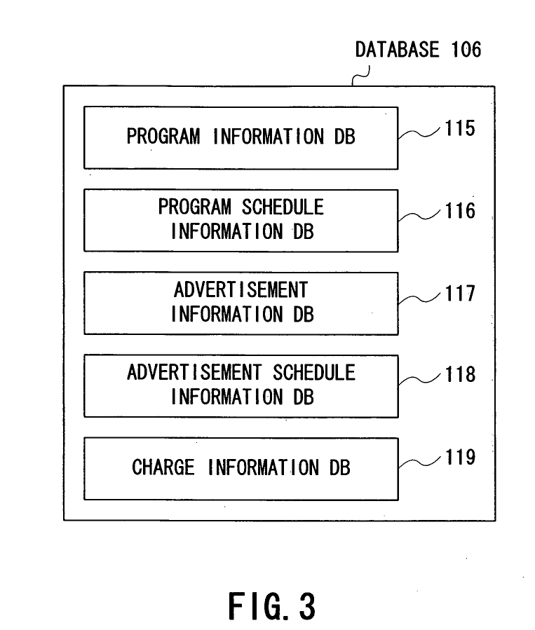

The database 106 is a database (DB) which stores various kinds of information relating to the advertisement presentation aiding system 100. FIG. 3 shows the structure of the database 106. As illustrated in the diagram, the database 106 includes a program information DB 115, a program schedule information DB 116, an advertisement information DB 117, an advertisement schedule information DB 118, and a charge information DB 119, which will be discussed in detail below.

The program information DB 115 stores information about a TV program which is distributed by TV station 101.

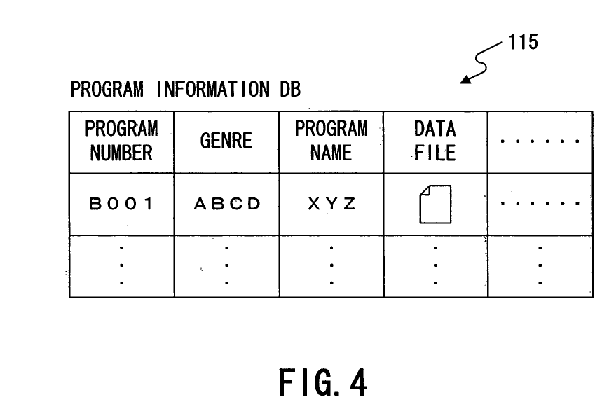

FIG. 4 shows an example of the program information DB 115. The program information DB 115 includes program numbers, genres, program names, and data flies indicating program contents.

The program schedule information DB 116 stores information about a schedule of TV programs to be distributed.

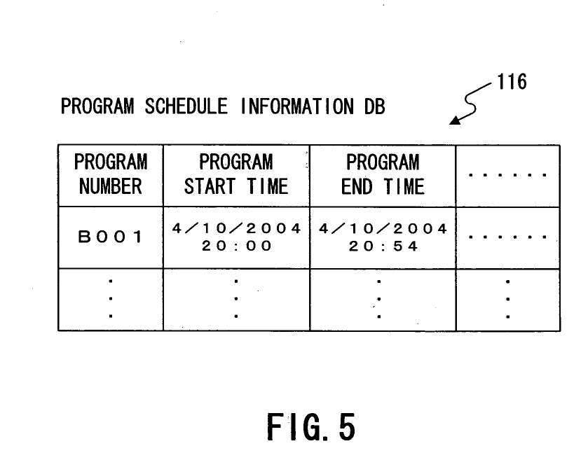

FIG. 5 shows an example of the program schedule information DB 116. The program schedule information DB 116 includes program numbers, program start times, and program end times.

For example, an electronic program guide (EPG) service, which allows a program guide and program associated information to be viewed on a TV screen, distributes information stored in the program schedule information DB 116 and the program information DB 115 together with program contents.

The advertisement information DB 117 stores information about advertisements.

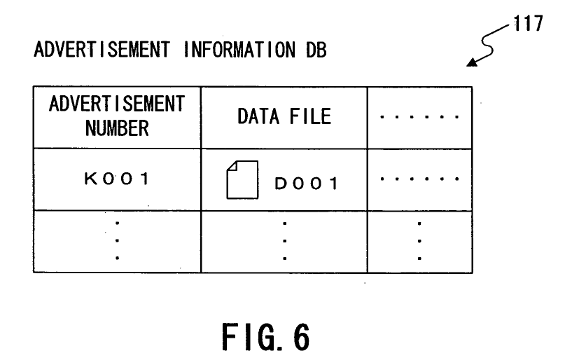

FIG. 6 shows an example of the advertisement information DB 117. As apparent from the diagram, the advertisement information DB 117 includes advertisement numbers, and data files, such as images indicating advertisement contents. Examples of the images indicating advertisement contents are an image indicating a company name which advertises and the name of a commodity, an image indicating a campaign information, and an image indicating a coupon. The images indicating advertisement contents may be barcodes.

For instance, the user of the advertisement presenting apparatus 102 prints an image indicating advertisement contents on the top surface of a DVD using the advertisement presenting apparatus 102. Then, the user presents the DVD on which the image indicating program contents is printed or the display screen of a cell phone which has shot an the indicating advertisement contents, at a shop equipped with the advertisement presentation aiding system 100. A sales person at the shop provides the user with services, such as price discount and distribution of a coupon according to the image indicating the advertisement contents.

Advertisement information stored in the advertisement information DB 117 is premised on that the following conditions should be fulfilled.

The advertisement information should be registered before delivery of TV programs. Further, the advertisement information should be delivered according to a schedule stored in the advertisement schedule information DB 118 to be discussed later. The advertisement information should be delivered together with information stored in the program information DB 115 and the program schedule information DB 116.

The advertisement schedule information DB 118 stores information about a schedule of advertisements to be delivered.

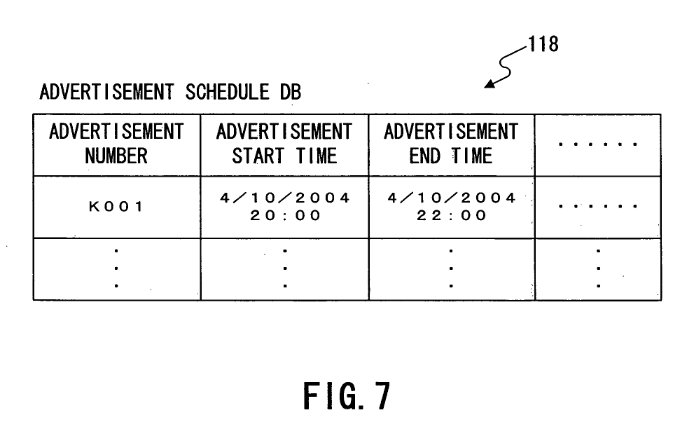

FIG. 7 shows an example of the advertisement schedule information DB 118. The advertisement schedule information DB 118 includes advertisement numbers, advertisement start times and advertisement end times.

The charge information DB 119 stores information about calculation of advertising rates.

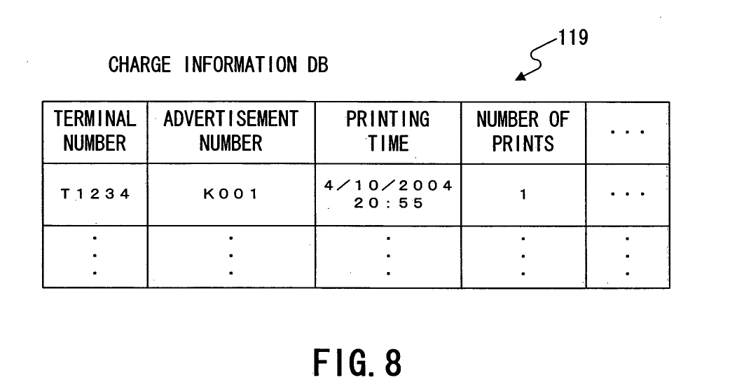

FIG. 8 shows an example of the charge information DB 119. The charge information DB 119 includes terminal numbers, advertisement numbers, print times and the numbers of prints. The terminal number is a number unique to each advertisement presenting apparatus 102.

The server 105 calculates an advertising rate based on the charge information DB 119 every predetermined time (specifically, at 12:00 every Friday, for example). Next, the server 105 sends data on the calculated advertising rate to the advertisement terminal 104 of the advertiser. Accordingly, the TV station 101 charges the advertiser for the advertising rate.

Suppose that the user of the advertisement presenting apparatus 102 has recorded a TV program. The advertisement presenting apparatus 102 prints an advertisement or so on the top surface of a DVD after recording of the program. Further, the advertisement presenting apparatus 102 sends an advertisement print notification 280 to the server 105 over the communication network 103. The advertisement presenting apparatus 102 may send notifications to the server 105 at a time at a predetermined timing (specifically, at 3:00 A.M. everyday, for example). The server 105 receives the advertisement print notification 280 and updates the charge information DB 119. The server 105 calculates a advertising rate every predetermined time and charges the advertiser for the advertising rate.

The configuration of the advertisement presenting apparatus 102 will be discussed next.

The advertisement presenting apparatus 102, like a DVD recorder, for example, receives and records TV programs or the like delivered from the TV station 101. The advertisement presenting apparatus 102 also prints an image indicating advertisement contents on the top surface of an information recording medium.

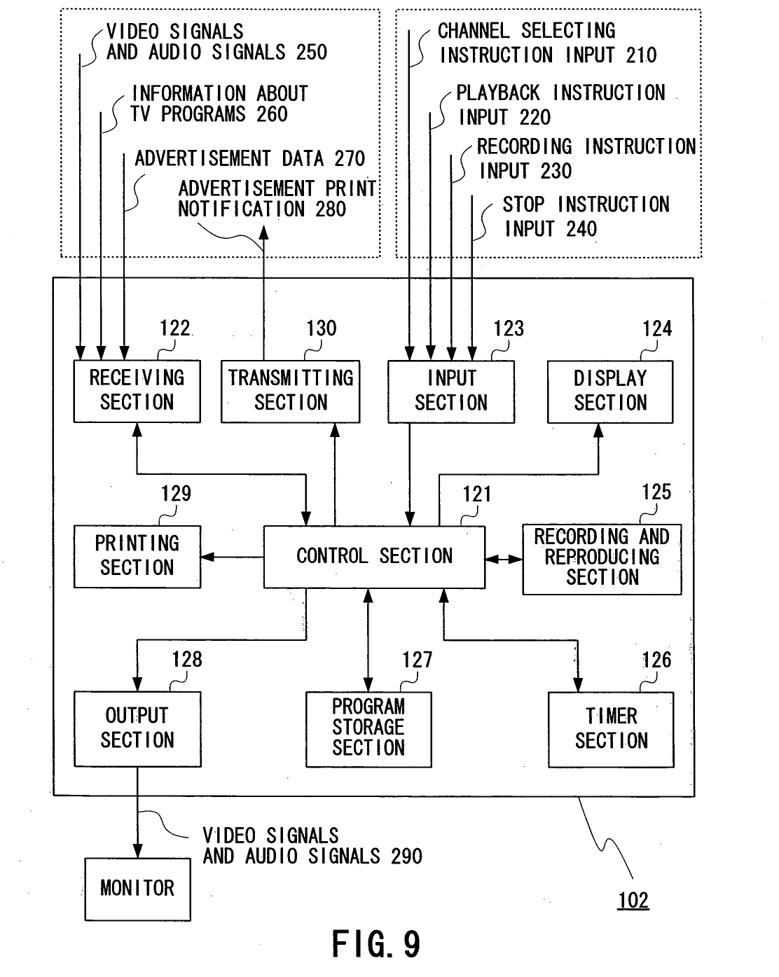

FIG. 9 shows the configuration of the advertisement presenting apparatus 102. As shown in the diagram, the advertisement presenting apparatus 102 comprises a control section 121, a receiving section 122, an input section 123, a display section 124, a recording/reproducing section 125, a timer section 126, a program storage section 127, an output section 128, a printing section 129, and a transmitting section 130, which will be specifically discussed below.

The control section 121 comprises, for example, a CPU, a predetermined memory device (e.g., RAM (Random Access Memory), ROM (Read Only Memory) or the like). The control section 121 controls the individual sections of the advertisement presenting apparatus 102.

The receiving section 122, which is constituted by a predetermined receiving apparatus, receives video signals/audio signals 250 delivered from the TV station 101. The receiving section 122 has a tuner to select and receive one of plural TV programs.

The receiving section 122 receives information 260 about the TV program. For example, the receiving section 122 receives the program name, program start time, program end time, etc. of the TV program through the EPG.

The receiving section 122 also receives an image indicating, for example, advertisement contents.

The input section 123 receives a channel selecting instruction input 210, a playback instruction input 220, a recording instruction input 230 and a stop instruction input 240. That is, when a user depresses any of various kinds of operation buttons provided on the advertisement presenting apparatus 102, the input section 123 accepts a predetermined operation command for the depressed button.

When the user depresses a record button, for example, the recording instruction input 230 is input to the input section 123. The recording instruction input 230 is further input to the control section 121. The control section 121 causes the recording/reproducing section 125 to start recording the received TV program.

The display section 124, which is constituted by a liquid crystal display, for example, displays the current operation status of the advertisement presenting apparatus 102.

The recording/reproducing section 125 retains an information recording medium such as a DVD. The recording/reproducing section 125 may have a rewritable memory device, such as a hard disk unit. The recording/reproducing section 125 performs recording (reproducing) and writing (recording) of the information recording medium under the control of the control section 121.

The timer section 126 measures the current time. For example, the time measured by the timer section 126 is used as a recording date on which information is recorded on the top surface of a DVD.

The program storage section 127 is constituted by a recording apparatus, such as a hard disk unit or ROM. The program storage section 127 holds various kinds of programs that are executed by the control section 121. For example, the program storage section 127 holds a program by which the control section 121 causes the recording/reproducing section 125 to record information on a DVD when a request to record information on a DVD is given by a user through the input section 123.

The program storage section 127 stores a program by which the control section 121 causes the printing section 129 to print predetermined information on the top surface of the information recording medium such as a DVD. For example, the printing program automatically generates information which allows a user to grasp the recorded contents, such as the name of a recorded program and a recording date, and prints the information on the top surface of a DVD. The printing program also automatically calculates the remaining recording time to additionally record data on the DVD for each recording mode, and prints the remaining recording time on the top surface of the DVD. Other print items include a genre icon, a recording mode, a standard logotype, and a media maker logotype. When music is to be recorded on a CD, for example, the print items include a CD title, the name of an artist, names of music pieces, and a media maker logotype.

The output section 128 is connected to the display apparatus, such as a monitor. The output section 128 outputs video signals/audio signals 290 to the display apparatus, such as a monitor. That is, the output section 128 sends the video signals/audio signals 250, received by the receiving section 122, and video signals/audio signals, played back by the recording/reproducing section 125, to the display apparatus, such as a monitor, directly or after decoding the video signals/audio signals.

The printing section 129 prints predetermined information on the top surface of the information recording medium, such as a DVD, according to the printing program that is executed by the control section 121.

The transmitting section 130 is connected to the communication network 103. The transmitting section 130 sends the advertisement print notification 280 to the server 105. The advertisement print notification 280 is sent when the advertisement is printed or advertisement print notifications 280 are sent to the server 105 at a time at a predetermined timing (specifically, at 3:00 A.M. everyday, for example).

The advertisement presenting apparatus 102 may be equipped with a remote control unit to remotely control the advertisement presenting apparatus 102. In this case, the advertisement presenting apparatus 102 is separately provided with a receiving section to receive a control code sent from the remote control unit.

The communication network 103; is, for example, the Internet, LAN (Local Area Network), WAN (Wide Area Network) or the like.

The advertisement terminal 104 is to be used by a person in charge in an enterprise who advertises using the advertisement presentation aiding system 100. For example, the advertisement terminal 104 comprises a computer having a communication capability, a portable terminal and so forth. An advertiser records an image or the like indicating advertisement contents in the database 106 using the advertisement terminal 104.

The use of the advertisement presentation aiding system 100 by the user who has the advertisement presenting apparatus 102 is premised on that individual pieces of information have been recorded in the database 106 of the TV station 101.

Specifically, information about a TV program to be delivered should have been registered in the program information DB 115 by a person in charge in the TV station 101. Further, information about the schedule of the TV program should have been registered in the program schedule information DB 116 by the person in charge in the TV station 101.

Further, information or so about an advertisement should have been registered in the database 106 of the TV station 101 by a person in charge in an enterprise who gives the advertisement by using, for example, the advertisement terminal 104.

Specifically, information about an advertisement should have been registered in the advertisement information DB 117 by the person in charge in the enterprise who gives the advertisement. In addition, the schedule of the advertisement to be delivered should have been registered in the advertisement schedule information DB 118 by the person in charge in the enterprise who gives the advertisement.

It is premised that the person in charge in the enterprise who gives the advertisement should have been registered beforehand so that the person can log in the system. For example, the person in charge in the enterprise who gives the advertisement logs in the advertisement presentation aiding system 100 using a user ID and a password given beforehand through the advertisement terminal 104 and can perform various operations.

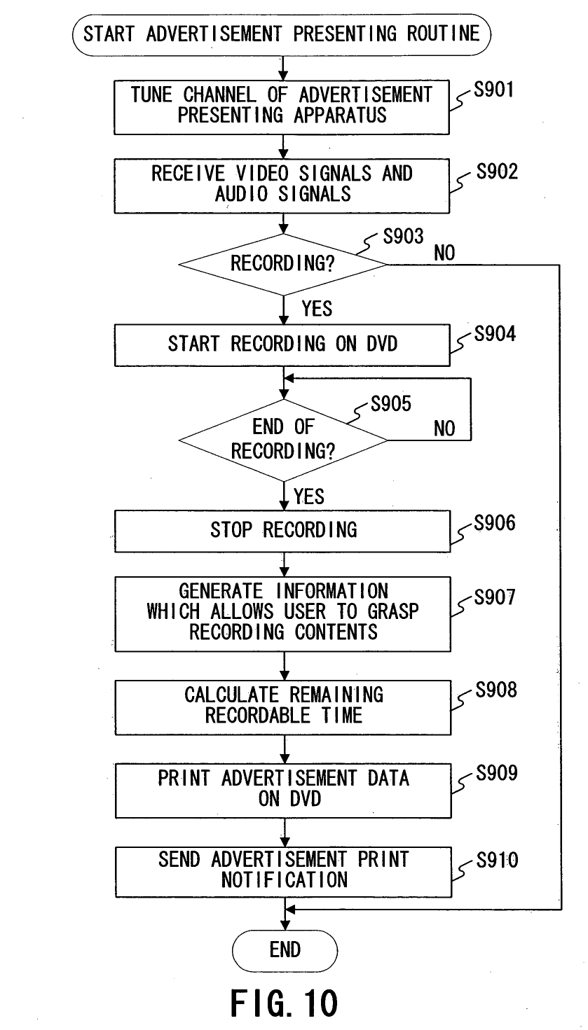

An advertisement presenting routine which is carried out by the advertisement presenting apparatus 102 will be described below. FIG. 10 is a flowchart illustrating, in detail, the advertisement presenting routine that is executed by the advertisement presenting apparatus 102.

First, the user of the advertisement presenting apparatus 102 inputs the channel selecting instruction input 210. The channel selecting instruction input 210 includes the number of a TV channel selected by the user. The input section 123 accepts the channel selecting instruction input 210.

Next, the control section 121 tunes the number of the channel to be received by the receiving section 122 to the channel number designated by the channel selecting instruction input 210 (step S901). The receiving section 122 receives the video signals/audio signals 250 or the like of a TV program delivered from the TV station 101 which corresponds to the channel number (step S902).

That is, depressing a channel select button, the user can select and view a desired TV program.

As mentioned earlier, information to be delivered from the TV station 101 includes the information 260 about the TV program in addition to the video signals/audio signals 250 of the TV program. For example, the information about a TV program includes a program name, a genre name, a program start time and a program end time.

For instance, program information is stored in the database 106 of the TV station 101 as shown in FIG. 4, and program schedule information is stored as shown in FIG. 5. In this case, the TV program with the program number “B001” has a genre name “ABCD”, a program name “XYZ”, a program start time “2004 April 10 20:00” and a program end time “2004 April 10 20:54”. Those pieces of information are delivered to the user through, for example, an EPG.

Further, information to be delivered from the TV station 101 includes the advertisement data 270 which is so set as to be delivered at the broadcast time of the TV program.

For example, the database 106 of the TV station 101 holds advertisement information as shown in FIG. 6 and advertisement schedule information as shown in FIG. 7. For the program number “B001”, advertisement data indicated by an advertisement number “K001” is registered at the broadcast time of the TV program. Also registered in the database 106 is image data “D001” indicating advertisement contents corresponding to the advertisement number “K001”. At the time zone where the TV station 101 delivers the TV program with the program number “B001”, therefore, image data “D001” corresponding to the advertisement number “K001” is delivered to the advertisement presenting apparatus 102.

That is, the advertisement presenting apparatus 102 receives information about the schedule of the TV program with the program number “B001”, information about the TV program and the image data “D001” indicating advertisement contents corresponding to the advertisement number “K001” at the same time as receiving the TV program. Then, the advertisement presenting apparatus 102 prints an image or so indicating advertisement contents on the top surface of a DVD using the received pieces of information.

Although a data file corresponding to an advertisement number is an image indicating advertisement contents, the image may include character data indicating advertisement contents. In this case, after receiving the character data indicating advertisement contents, the advertisement presenting apparatus 102 edits the character data using character fonts provided in the apparatus and prints the edited character data on the top surface of the DVD.

Next, the control section 121 discriminates whether or not the user has instructed recording of the program or not (step S903). When the control section 121 discriminates that the user has not instructed recording of the program or not (NO at step S903), the control section 121 terminates the advertisement presenting routine.

When the control section 121 discriminates that the user has instructed recording of the program or not (YES at step S903), the control section 121 starts a recording process according to the instruction given through the input section 123 (step S904). Specifically, the control section 121 reads a recording program from the program storage section 127. Then, the control section 121 controls the individual sections of the advertisement presenting apparatus 102, such as the recording/reproducing section 125, according to the recording program.

Next, the control section 121 determines whether or not recording should be terminated or not (step S905). The decision is made in response to the stop instruction input 240 given to the input section 123 by the user.

When the control section 121 determines that recording is to be terminated (YES at step S905), the control section 121 instructs the recording/reproducing section 125 to stop recording (step S906). The control section 121 reads the printing program from the program storage section 127. Further, the control section 121 generates information which allows the user to grasp recorded contents, such as the name of the recorded program and the recording date, according to the read printing program (step S907). For example, the program name is generated based on the information 260 about the program which has been received at the same time as the TV program. The recording date, for example, is generated based on the date that is acquired from the timer section 126.

Recording of the TV program may be scheduled by a timer, for example. In this case, first, the control section 121 acquires the current time from the timer section 126 and determines whether the time has reached the recording start time or not. When the current time reaches the recording start time, the control section 121 causes the recording/reproducing section 125 to start recording (step S905). When the current time reaches the recording end time, the control section 121 causes the recording/reproducing section 125 to stop recording (step S906). Thereafter, the control section 121 generates information which allows the user to grasp the recorded contents according to the printing program (step S907).

Next, the control section 121 calculates the recordable time remaining for additional information to be recorded (step S908). The remaining recording/reproducing section 125 calculates the recordable time for each recording mode (specifically, a standard image quality mode, a high image quality mode or the like) based on the amount of data recorded on the DVD and the entire capacitance of the DVD.

Further, the control section 121 causes the printing section 129 to print information which allows the user to grasp recorded contents and the image indicating advertisement contents on the top surface of the DVD (step S909).

Then, the control section 121 causes the transmitting section 130 to send the advertisement print notification 280 to the server 105 over the communication network 103 (step S910). The server 105 receives the advertisement print notification 280 and updates the charge information DB 119.

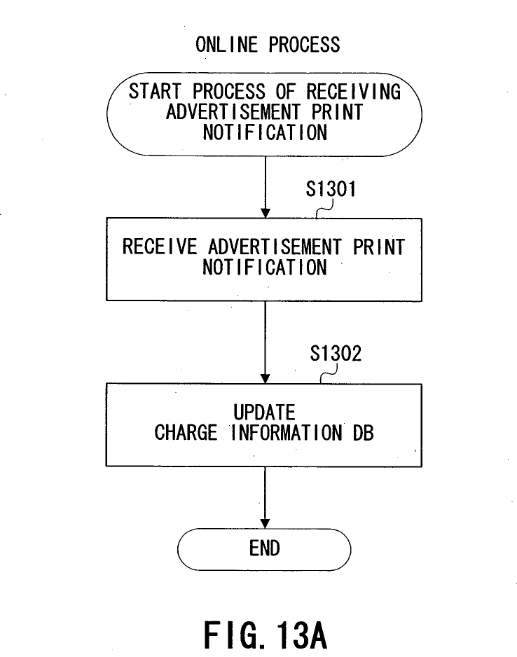

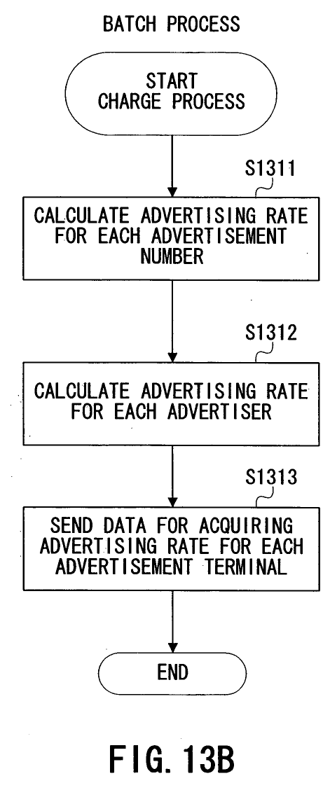

The charging process that the server 105 performs will be discussed next. FIG. 13A is a flowchart illustrating a process of receiving an advertisement print notification. This process is executed in real time by the server 105. FIG. 13 is a flowchart illustrating a routine for computing an advertising rate. This process is executed by, for example, a batch by the server 105.

First, the server 105 receives the advertisement print notification 280 from the advertisement presenting apparatus 102 (step S1301). Next, the server 105 writes information indicating that an advertisement with the advertisement number has been printed in the charge information DB 119 (step S1302). When an advertisement with the advertisement number “K001” is printed by the advertisement presenting apparatus 102, for example, the server 105 writes the unique number of the advertisement presenting apparatus 102, the print time, the number of prints, etc. in the charge information DB 119. Although the advertisement presenting apparatus 102 sends the advertisement print notification 280 immediately after printing the advertisement in the embodiment, the advertisement presenting apparatus 102 may send collected pieces of data every predetermined time.

The server 105 performs a batch process of charging the advertising rate every predetermined time. First, the server 105 collects all the records of executed advertisements recorded in the charge information DB 119 (step S1311). Further, the server 105 calculates the advertising rate for each advertiser based on the counting result for each advertisement number (step S1312). The server 105 then sends data on the calculated advertising rate or so to the advertisement terminal 104 (step S1313). Accordingly, the advertisement presenting apparatus 102 charges the advertiser for the capacitive element.

Suppose that a TV program with the program number “B001” is scheduled for recording by the user. When the time comes to the recording start time, the advertisement presenting apparatus 102 starts recording the TV program with the program number “B001”. When the time comes to the recording end time, the advertisement presenting apparatus 102 stops recording the program. Thereafter, the advertisement presenting apparatus 102 prints information, such as the program name, the recording date and the recording mode of the program, the remaining recordable time, and an image indicating advertisement contents on the top surface of a DVD. Then, the advertisement presenting apparatus 102 sends the advertisement print notification 280 indicating that the image indicating the advertisement contents has been printed once. The server 105 receives the advertisement print notification 280 and updates the charge information DB 119. Further, the server 105 calculates the advertising rate every predetermined time. Then, the server 105 charges the advertiser for the advertising rate.

That is, as advertisement contents are printed on the top surfaces of DVDs that are used by users, the advertiser can use the DVDs as an advertisement media. This can provide the users of the advertisement presenting apparatuses 102 with an effective advertisement. Registering images or so indicating advertisement contents in the database 106, the advertiser has only to pay the advertising rate for the actual advertisements done to the TV station.

The user needs not record information about a recorded program, for example, in handwriting, later. Therefore, the user can avoid confusing the contents of a DVD from another DVD which would otherwise occur if the user forgot recording information on the recorded program. Further, the user can check the remaining recordable time or the like at a glance.

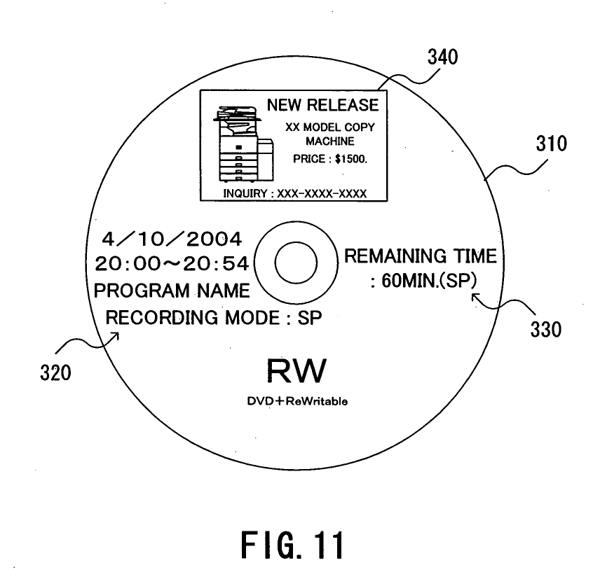

FIG. 11 shows one example of a DVD on whose top surface advertisement information or so is printed using the advertisement presenting apparatus 102. As shown in the diagram, information 320 about a recorded program, which is comprised of the recording date, the program name and the recording mode, a remaining recordable time 330, and an image 340 indicating advertisement contents are printed on the top surface of a DVD 310. As the image 340 indicating advertisement contents is printed on the top surface of the DVD 310, the DVD can be used as an advertisement medium, thus providing a more effective advertisement.

For example, the image 340 indicating advertisement contents may be a barcode. In this case, the user of the advertisement presenting apparatus 102 presents a barcode-printed DVD or the display screen or the like of a cell phone which has shot the barcode at a shop where the advertisement presentation aiding system 100 is used. A sales person at the shop reads the barcode using a predetermined barcode reader. The sales person can provide the user of the advertisement presenting apparatus 102 with services, such as price discount and distribution of a coupon according to the read information. The advertiser can use the DVD as an advertisement medium and can thus give an effective advertisement.

Seeing the information printed on the top surface of the DVD 310, the user of the advertisement presenting apparatus 102 can easily know the contents recorded on the DVD 310. At this time, the user of the advertisement presenting apparatus 102 need not play back the DVD 310 to check the contents. The user of the advertisement presenting apparatus 102 needs not record the recorded contents, for example, in handwriting, on the top surface of the DVD 310 after recording is finished.

According to the embodiment, as described above, the advertiser can use a DVD as an advertisement by printing an image indicating advertisement contents on the top surface of the DVD. Accordingly, the advertiser can take an effective advertising action to the user of the advertisement presenting apparatus 102.

According to the embodiment, viewing information about a recorded program and a remaining recordable time printed on the top surface of a DVD, the user of the advertisement presenting apparatus 102 can easily know the contents of the DVD.

The invention is not limited to the embodiment, but can be modified and adapted in various forms. Other embodiments adaptable to the invention will be discussed below.

### Second Embodiment

Although the foregoing description of the invention has been given of the case where information about a program and information about an advertisement are delivered simultaneously from the TV station 101, those two kinds of information may be delivered at different timings.

Suppose that the user of the advertisement presenting apparatus 102 has started recording a TV program using the advertisement presenting apparatus 102. The control section 121 of the advertisement presenting apparatus 102 notifies the server 105 of the TV station 101 that recording of the TV program has started. Upon reception of the notification, the server 105 sends image data or so on an advertisement to the advertisement presenting apparatus 102. The advertisement presenting apparatus 102 in turn receives the image data or so on the advertisement.

That is, the TV station 101 does not deliver the advertisement data 270 until the advertisement presenting apparatus 102 prints the advertisement.

Accordingly, the TV station 101 can suppress the amount of data to be delivered to the advertisement presenting apparatus 102. The advertisement presentation aiding system 100 can reduce the traffic over the communication network 103 and the load on the server 105.

### Third Embodiment

Although the foregoing description of the embodiments has been given of the case where programs to be delivered from the TV station 101 are recorded on a DVD, the advertisement presenting apparatus may record music or the like on an information recording medium such as a CD-R.

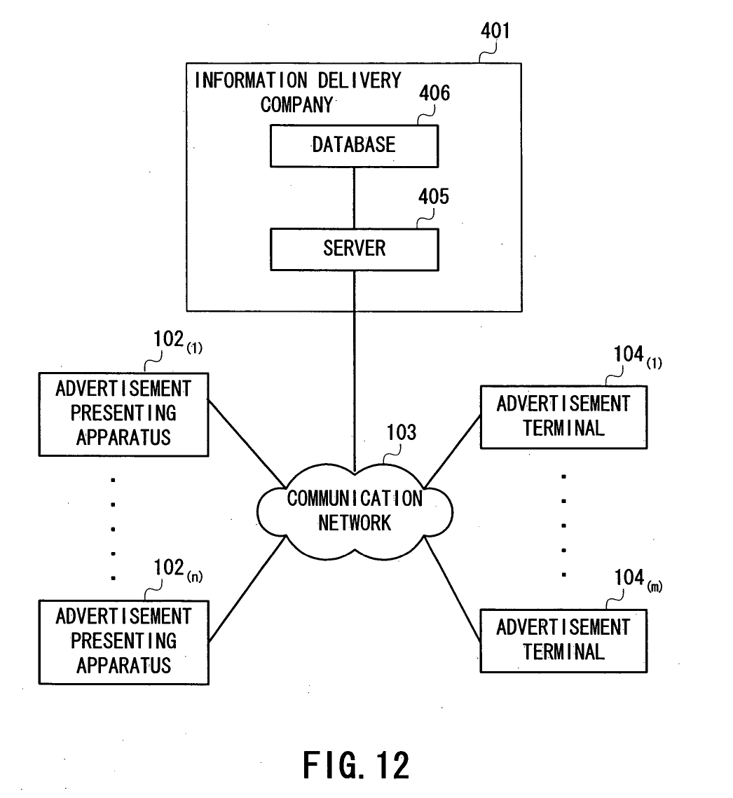

FIG. 12 exemplifies the configuration of a system in which an information delivery company 401 delivers information on music or the like over the communication network 103.

In this case, the advertisement presenting apparatus 102 receives music data or the like delivered over the communication network 103 and records the music data or the like on a CD-R. Further, the advertisement presenting apparatus 102 receives information about music and an image associated with an advertisement, both delivered over the communication network 103, and prints the information and the image on the top surface of a CD-R.

Therefore, an advertiser can use a CD-R as an advertisement medium. Accordingly, the advertiser can take an effective advertising action to the user of the advertisement presenting apparatus 102.

### Fourth Embodiment

The advertisement presenting apparatus 102 automatically generates information which allows the user to grasp the contents of a disk, such as the names of a recorded file and a recorded folder, and the recording date, and prints the information on the disk. That is, of data to be printed on the top surface of an information recording medium, data other than the advertisement print notification 280 is generated by the advertisement presenting apparatus 102.

Suppose that pieces of music are to be recorded on a CD-R. In this case, the advertisement presenting apparatus 102 acquires music name information from, for example, a CDDB (CD DataBase) accessible over the communication network 103, and prints the information on the CD-R. The advertisement presenting apparatus 102 calculates the remaining capacity for additional recording and prints the remaining capacity on the CD-R. Further, a volume name (disk title), a directory tree (or file names), and a last recording date, for example, may be printed.

### Fifth Embodiment

Contents to be printed on the top surface of a DVD may be modified. In the embodiments, the information 320 about a recorded program, which includes the recording date, the program name and the recording mode, the remaining recordable time 330, and the image 340 indicating advertisement contents is printed on the top surface of the DVD 310. However, at least the image 340 indicating advertisement contents should be printed, and the information 320 about the recorded program and the remaining recordable time 330 need not be printed.

Information to be printed on the top surface of the DVD 310 is not limited to those types of information, and various other types of information may be printed.

For example, a TV station may give an advertisement as an advertiser by delivering a title image or the like of a TV program to be delivered from the TV station.

Further, a scheme of printing information about a recorded program, image data indicating advertisement contents, and the like can be modified.

For instance, not only such information and image data are printed on the top surface of a DVD but also a label to be stuck on a DVD case may be printed together.

The advertisement presenting apparatus 102, the advertisement terminal 104 and the server 105 according to the embodiments of the invention can be realized by using an ordinary system, not using an exclusive system.

For example, programs for executing the above-described processes can be installed into an ordinary personal computer or the like from a recording medium (a flexible disk, a CD-ROM or the like) where the programs are stored. This can ensure easy configuration of the advertisement presenting apparatus 102, the advertisement terminal 104 and the server 105 which execute the processes.

Means for supplying the programs is arbitrary. The programs can be supplied via a predetermined recording medium as discussed above, or may be supplied via, for example, a communication circuit, a communication network, a communication system or the like. In this case, the programs may be described on, for example, a bulletin board system (BBS) on the communication network 103 and may be provided over the communication network 103. As the programs provided this way are invoked and are run under the control of the OS in the same way as other application programs, the above-described processes can be executed.

As described above, the present invention can provide an advertisement presenting apparatus, an advertisement presentation aiding system and an advertisement presenting method which are suitable for presenting an advertisement on the top surface of an information recording medium.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-134232 filed on Apr. 28, 2004 and including specification, claims, drawings and summary. The disclosure of the above Japanese Patent Application is incorporated herein by reference in its entirety.

1. An advertisement presenting apparatus comprising:
a record information receiving section which receives record information to be recorded in an information recording medium;
an advertisement image information receiving section which receives advertisement image information indicating contents of an advertisement;
a recording section which records said record information, received by said record information receiving section, in said information recording medium; and
a presenting section which presents said advertisement image information, received by said advertisement image information receiving section, on a top surface of said information recording medium where said record information is recorded by said recording section.

2. The advertisement presenting apparatus according to claim 1, wherein said advertisement image information receiving section receives advertisement image information corresponding to said record information received by said register section.

3. The advertisement presenting apparatus according to claim 2, wherein said advertisement image information receiving section receives advertisement image information corresponding to a time at which said record information is recorded in said information recording medium by said recording section.

4. The advertisement presenting apparatus according to claim 1, wherein said presenting section presents, on said top surface of said information recording medium, information by which contents of said record information recorded in said information recording medium by said recording section can be grasped.

5. The advertisement presenting apparatus according to claim 4, wherein said information by which said contents of said record information can be grasped includes at least one of a genre, a title, a recording date, a recording mode and a remaining recordable time.

6. An advertisement presentation aiding system which presents advertisement image information indicating contents of an advertisement on a top surface of an information recording medium, and comprises an advertisement presenting apparatus as recited in claim 1.

7. The advertisement presentation aiding system according to claim 6, further comprising a server unit comprising:
a record information storing section which stores record information recordable in an information recording medium;
an advertisement image information storing section which stores advertisement image information indicating contents of an advertisement in association with said record information;
a record information transmitting section which transmits said record information stored in said information recording medium; and
an advertisement image information transmitting section which transmits said advertisement image information stored in said advertisement image information storing section, and transmits advertisement image information associated with said record information transmitted by said record information transmitting section.

8. The advertisement presentation aiding system according to claim 7, wherein said advertisement image information transmitting section transmits advertisement image information corresponding to a time at which said record information transmitting section has transmitted said record information.

9. An advertisement presenting method comprising:
a record information receiving step at which record information to be recorded in an information recording medium is received;
an advertisement image information receiving step at which advertisement image information indicating contents of an advertisement is received;
a recording step at which said record information, received at said record information receiving step, is recorded in said information recording medium; and
a presenting step at which said advertisement image information, received at said advertisement image information receiving step, is presented on a top surface of said information recording medium where said record information is recorded at said recording step.

10. A program for allowing a computer to function as:
a record information receiving section which receives record information to be recorded in an information recording medium;
an advertisement image information receiving section which receives advertisement image information indicating contents of an advertisement;
a recording section which records said record information, received by said record information receiving section, in said information recording medium; and
a presenting section which presents said advertisement image information, received by said advertisement image information receiving section, on a top surface of said information recording medium where said record information is recorded by said recording section.
